(19) United States
(12) Patent Application Publication
(10) Pub. No.: US 2022/0352799 A1
(43) Pub. Date: Nov. 3, 2022

(54) ROTARY MOTOR AND ROBOT ARM

(71) Applicant: SEIKO EPSON CORPORATION, Tokyo (JP)

(72) Inventors: Hideaki NISHIDA, SUWA-SHI (JP); Kuniaki TANAKA, MATSUMOTO-SHI (JP)

(21) Appl. No.: 17/731,273

(22) Filed: Apr. 28, 2022

(30) Foreign Application Priority Data
Apr. 30, 2021 (JP) 2021-077274

(51) Int. Cl. H02K 16/04; H02K 1/2796; H02K 7/00; H02K 21/24; B25J 9/12; B25J 19/00

(52) U.S. Cl. CPC H02K 16/04; H02K 1/2796; H02K 7/003; H02K 21/24; B25J 9/126; B25J 19/0025

(57) ABSTRACT

A motor includes a stator and a rotor, the rotor includes a frame coupled to a rotation shaft and a magnet fixed to the frame, with a direction from the stator toward the rotor as a first direction, the magnet includes a plurality of lower part main pole magnets having a magnetization direction in the first direction and pluralities of lower part second rightward sub-magnets and lower part second leftward sub-magnets having a magnetization direction in a direction different from the first direction, the lower part main pole magnet includes a lower part first upward main magnet placed at a negative side in the first direction and a lower part second upward main magnet fixed to the frame, when the magnet is seen along the first direction, the lower part first upward main magnet and the lower part second rightward sub-magnet and lower part second leftward sub-magnet partially overlap.

The present application is based on, and claims priority from JP Application Serial Number 2021-077274, filed Apr. 30, 2021, the disclosure of which is hereby incorporated by reference herein in its entirety.

### BACKGROUND

1. Technical Field

The present disclosure relates to a rotary motor and a robot arm.

2. Related Art

JP-A-2004-015906 discloses a radial gap motor in a Halbach array. According to the motor, a rotor has a Halbach magnet array. In the Halbach magnet array, main permanent magnets as main pole magnets having a magnetization direction in a radial direction and auxiliary permanent magnets as sub-pole magnets having a magnetization direction in a circumferential direction are alternately placed.

A stator is placed at the outer circumferential side of the rotor. As the poles of the main permanent magnets at the stator side, N-poles and S-poles are alternately placed. In the auxiliary permanent magnets, N-poles and S-poles are adjoiningly placed in the circumferential direction. The main permanent magnets and the auxiliary permanent magnets are arranged in the Halbach magnet array.

Magnetic flux exits from the N-pole of the main permanent magnet toward an air gap. The magnetic flux passes over the auxiliary permanent magnet and enters the S-pole of the other main permanent magnet. The magnetic flux entering the S-pole transfers to the N-pole of the main permanent magnet. The magnetic flux transferring to the N-pole passes through the auxiliary permanent magnet, passes the S-pole of the original main permanent magnet, and transfers from the S-pole to the N-pole. As described above, the magnetic flux forms a circulating magnetic circuit.

However, in the Halbach magnet array of JP-A-2004-015906, the main permanent magnets on both sides of the auxiliary permanent magnet are apart. Accordingly, the magnetic flux passing through the auxiliary permanent magnet is hard to pass the surface portion facing the air gap of the auxiliary permanent magnet. As a result, the surface portion of the auxiliary permanent magnet may be demagnetized and the magnetic characteristics of the entire motor may be lower.

### SUMMARY

A rotary motor includes a stator including a coil, and a rotor placed with a gap between the coil and itself and rotating relative to the stator, wherein the rotor includes a rotor frame coupled to a rotation shaft and a magnet fixed to the rotor frame, with a direction from the stator to the rotor as a first direction, the magnet includes a plurality of main pole magnets having a magnetization direction in the first direction and a plurality of sub-pole magnets having a magnetization direction in a direction different from the first direction, the main pole magnet includes a first main pole magnet placed at a negative side in the first direction and a second main pole magnet placed at a positive side in the first direction and fixed to the rotor frame, the sub-pole magnet and the second main pole magnet contact each other in a surface facing a second direction orthogonal to the first direction, when the magnet is seen along the first direction, a part of the first main pole magnet and the sub-pole magnet overlap and a part of the first main pole magnet and the second main pole magnet overlap.

A robot arm includes the above described rotary motor.

### BRIEF DESCRIPTION OF THE DRAWINGS

FIG. 1 is a schematic side sectional view showing an overall configuration of a rotary motor according to a first embodiment.

FIG. 2 is a schematic plan view of a main part showing a configuration of a rotor.

FIG. 3 is a schematic side view of a main part for explanation of a configuration of a magnet.

FIG. 4 is a schematic side view of a main part for explanation of lines of magnetic force.

FIG. 5 is a schematic side view of a main part for explanation of a configuration of a magnet according to a second embodiment.

FIG. 6 is a schematic side view of a main part for explanation of a configuration of a magnet according to a third embodiment.

FIG. 7 is a schematic side view of a main part for explanation of a configuration of a magnet according to a fourth embodiment.

FIG. 8 is a schematic side view of a main part for explanation of a configuration of a magnet according to a fifth embodiment.

FIG. 9 is a schematic side view of a main part for explanation of a configuration of a magnet according to a sixth embodiment.

FIG. 10 is a schematic side view of a main part for explanation of a configuration of a magnet according to a seventh embodiment.

FIG. 11 is a schematic sectional view showing an overall configuration of a rotary motor according to an eighth embodiment.

FIG. 12 is a schematic plan view of a main part for explanation of a configuration of a magnet.

FIG. 13 is a schematic perspective view showing a configuration of a robot according to a ninth embodiment.

FIG. 14 is a schematic side view of a main part for explanation of a configuration of a magnet according to an example of related art.

### DESCRIPTION OF EXEMPLARY EMBODIMENTS

### First Embodiment

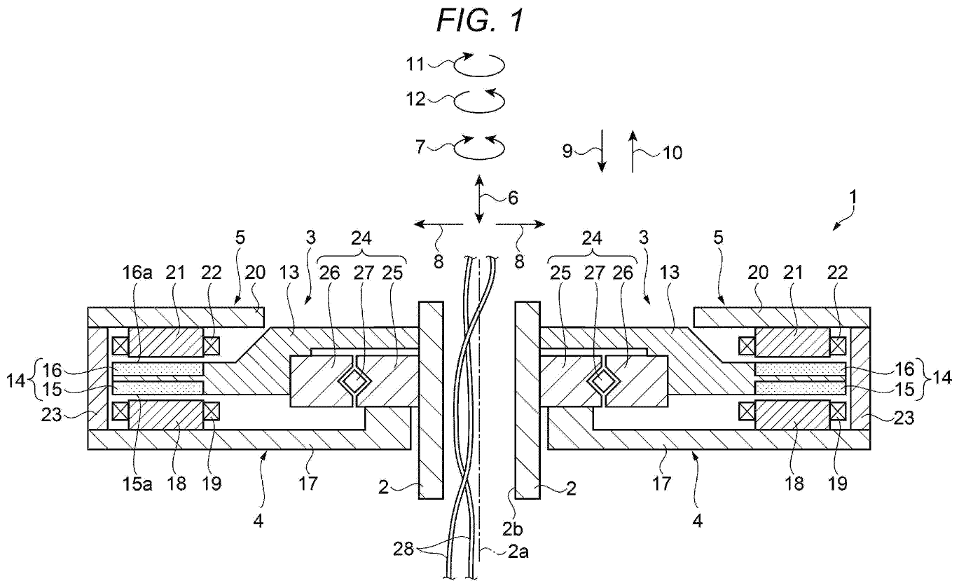

A motor 1 as a rotary motor shown in FIG. 1 is an axial gap motor employing a double-stator structure. The motor 1 includes a rotor 3 coupled to a rotation shaft 2 and having a disc shape rotating with the rotation shaft 2. The rotation shaft 2 and the rotor 3 rotate around a center axis 2a. The motor 1 includes a first stator 4 as a stator and a second stator 5 as a stator placed with the rotor 3 in between in an axial direction of the rotation shaft 2. The rotor 3 rotates relative to the first stator 4 and the second stator 5.

Directions along the center axis 2a are axial directions 6. Directions along the circumference of the rotor 3 are “circumferential directions 7 as second directions”. A direction outward along the radius of the rotor 3 is a radial direction 8. A direction from the second stator 5 toward the first stator 4 is a downward direction 9. A direction from the first stator 4 toward the second stator 5 is an upward direction 10. A clockwise direction as seen in the downward direction 9 is a first circumferential direction 11. A counterclockwise direction as seen in the downward direction 9 is a second circumferential direction 12.

The rotor 3 includes a frame 13 as a rotor frame and a permanent magnet 14 as a magnet supported by the frame 13. The frame 13 is coupled to the rotation shaft 2 and fixed to the rotation shaft 2. The permanent magnet 14 is bonded and fixed to the axial direction 6 side of the frame 13. The permanent magnet 14 is a magnetized magnet. The permanent magnet 14 includes a lower part permanent magnet 15 and an upper part permanent magnet 16. The lower part permanent magnet 15 and the upper part permanent magnet 16 overlap as seen from the axial directions 6. The permanent magnet 15 is placed at the first stator 4 side and the upper part permanent magnet 16 is placed at the second stator 5 side. A lower surface 15a of the lower part permanent magnet 15 faces the first stator 4 and an upper surface 16a of the upper part permanent magnet 16 faces the second stator 5.

The first stator 4 and the second stator 5 are placed to sandwich the rotor 3 from both sides in the axial directions 6. The first stator 4 is placed in the downward direction 9 of the rotor 3 via a gap. The second stator 5 is placed in the upward direction 10 of the rotor 3 via a gap.

The first stator 4 includes a bottom case 17 having an annular shape, a plurality of first stator cores 18, and first coils 19 placed in the respective first stator cores 18. The first stator cores 18 are placed in the upward direction 10 of the bottom case 17. Note that back yokes (not shown) are provided to connect the first stator cores 18 between the plurality of first stator cores 18.

The second stator 5 has a top case 20 having an annular shape, a plurality of second stator cores 21, and second coils 22 as coils placed in the respective second stator cores 21. The second stator cores 21 are placed in the downward direction 9 of the top case 20. Note that back yokes (not shown) are provided to connect the second stator cores 21 between the plurality of second stator cores 21.

Next, the configuration of the first stator 4 will be explained. The first stator 4 and the second stator 5 have the same configuration as each other and, as below, the first stator 4 will be representatively explained and the explanation of the second stator 5 will be omitted.

The constituent material of the bottom case 17 includes e.g. a metal material such as stainless steel, aluminum alloy, magnesium alloy, and titanium alloy, a ceramics material such as alumina and zirconia, and a resin material such as engineering plastic. Further, the constituent material of the bottom case 17 includes e.g. various fiber-reinforced plastics such as CFRP (Carbon Fiber Reinforced Plastics) and GFRP (Glass Fiber Reinforced Plastics). Furthermore, the constituent material of the bottom case 17 includes e.g. fiber-reinforced composite materials such as FRC (Fiber Reinforced Ceramics) and FRM (Fiber Reinforced Metallics).

The constituent material of the bottom case 17 is preferably a non-magnetic material. The bottom case 17 is harder to be affected by magnetic flux and a problem of torque reduction or the like is harder to occur. The non-magnetic material refers to a material having relative magnetic permeability substantially from 0.9 to 3.0.

The first stator 4 has the plurality of first stator cores 18. The first stator cores 18 are arranged at equal intervals along the circumferential directions 7. Each first stator core 18 is formed using e.g. various magnetic materials including a multilayered structure of magnetic steel sheets and a green compact of magnetic powder, particularly, a soft magnetic material.

The respective first stator cores 18 may be fixed to the bottom case 17 by e.g. melting, adhesives, welding, or the like, or engaged with the bottom case 17 using various engagement structures.

The first coil 19 is wound around the outer circumference of the first stator core 18. The first stator core 18 and the first coil 19 form an electromagnet. The first coil 19 may be a conducting wire wound around the first stator core 18 or a conducting wire may be wound around a bobbin or the like in advance and fitted around the outer circumference of the first stator core 18.

The motor 1 has an energizing circuit (not shown) and each first coil 19 is coupled to the energizing circuit. Each first coil 19 is energized with a predetermined cycle or predetermined pattern. For example, a three-phase alternating current is applied to each first coil 19, magnetic flux is generated from the electromagnet and a force acts on the facing permanent magnet 14. The state is cyclically repeated, and the rotor 3 rotates around the rotation shaft 2. The rotor 3 is placed with a gap between the first coils 19 and itself and rotates relative to the first stator 4. Similarly, the rotor 3 is placed with a gap between the second coils 22 and itself and rotates relative to the second stator 5.

The first stator 4 may be molded using a resin as a whole. By molding using a resin, the bottom case 17 and the first stator cores 18 may be fixed to each other.

The first stator 4 and the second stator 5 are coupled via a center case 23. The center case 23 is located at the outside of the rotor 3 and has a cylindrical shape.

The bottom case 17 and the frame 13 are rotatably coupled via a cross roller bearing 24. The cross roller bearing 24 includes an inner ring 25, an outer ring 26, and a roller 27. The bottom case 17 is coupled to the inner ring 25 and the frame 13 is coupled to the outer ring 26. The inner ring 25 and the outer ring 26 rotate relative to each other via the roller 27. The rotor 3 is rotatably supported relative to the first stator 4 and the second stator 5.

The rotation shaft 2 has a through hole 2b extending in the axial directions 6. Electric wires 28 are inserted through the through hole 2b.

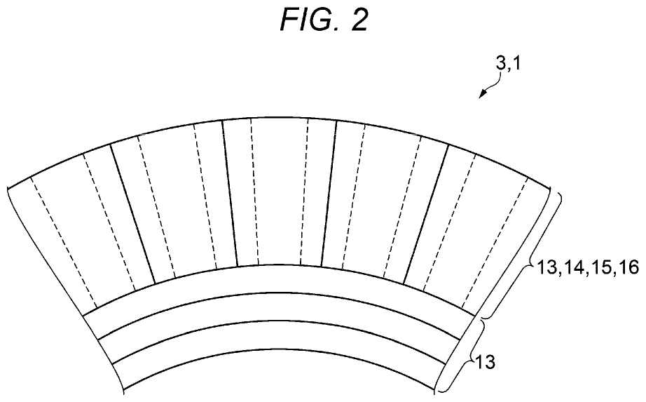

FIG. 2 is a plan view of the rotor 3 as seen in the downward direction 9. A part of the rotor 3 having the disc shape in the circumferential directions 7 is shown in FIG. 2. As shown in FIG. 2, the rotor 3 includes the frame 13 and the permanent magnet 14. The frame 13 has a disc shape. The constituent material of the frame 13 includes e.g. a metal material such as stainless steel, aluminum alloy, magnesium alloy, and titanium alloy, a ceramics material such as alumina and zirconia, and a resin material such as engineering plastic. In addition, the constituent material of the frame 13 includes e.g. various fiber-reinforced plastics such as CFRP (Carbon Fiber Reinforced Plastics) and GFRP (Glass Fiber Reinforced Plastics), and fiber-reinforced composite materials such as FRC (Fiber Reinforced Ceramics) and FRM (Fiber Reinforced Metallics).

The constituent material of the frame 13 is preferably a non-magnetic material. The frame 13 is harder to be affected by magnetic flux and a problem of torque reduction or the like is harder to occur. The non-magnetic material refers to a material having relative magnetic permeability substantially from 0.9 to 3.0.

The permanent magnet 14 includes, but is not limited to e.g. a neodymium magnet, a ferrite magnet, a samarium-cobalt magnet, an alnico magnet, and a bonded magnet.

The permanent magnet 14 is fixed to the frame 13 using e.g. an adhesive, a fastening tool, a binding tool, or the like. Or, both an adhesive and other means may be used. An adhesive or a molding resin may be placed to cover the permanent magnet 14. In the embodiment, for example, the permanent magnet 14 is bonded and fixed to the frame 13.

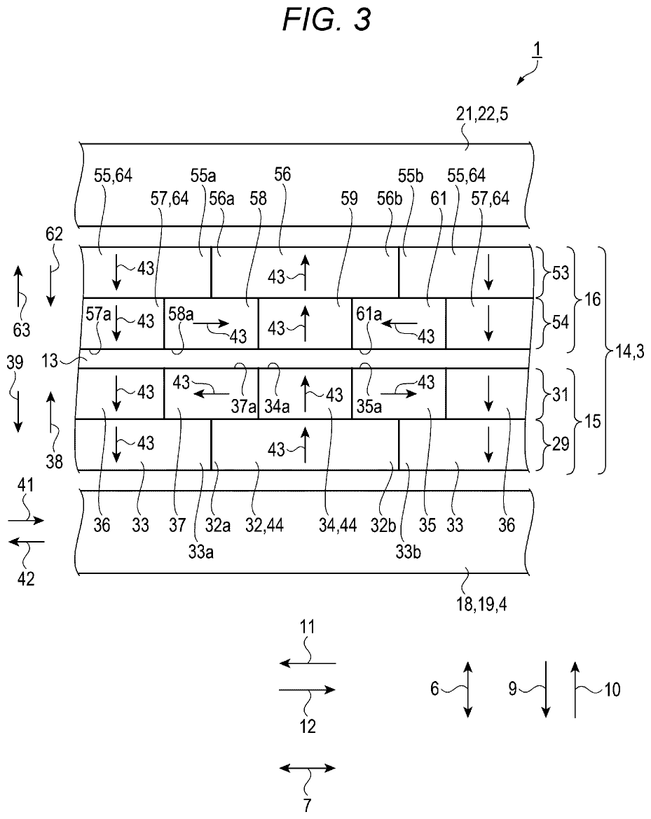

FIG. 3 shows the rotor 3 in FIG. 2 as seen from the opposite direction to the radial direction 8. As shown in FIG. 3, the permanent magnet 14 of the rotor 3 is placed in a Halbach magnet array.

The lower part permanent magnet 15 of the rotor 3 includes a lower part first permanent magnet 29 and a lower part second permanent magnet 31. The lower part first permanent magnet 29 is placed in the downward direction 9 of the lower part second permanent magnet 31.

The lower part first permanent magnet 29 includes a lower part first upward main magnet 32 as a main pole magnet and a first main pole magnet and a lower part first downward main magnet 33 as a first main pole magnet in contact with each other. The lower part first upward main magnet 32 and the lower part first downward main magnet 33 are sequentially repeatedly placed along the circumference of the rotation shaft 2.

The lower part second permanent magnet 31 includes a lower part second upward main magnet 34 as a main pole magnet and a second main pole magnet, a lower part second rightward sub-magnet 35 as a sub-pole magnet, a lower part second downward main magnet 36, and a lower part second leftward sub-magnet 37 as a sub-pole magnet in contact with each other. The lower part second upward main magnet 34, the lower part second rightward sub-magnet 35, the lower part second downward main magnet 36, and the lower part second leftward sub-magnet 37 are sequentially repeatedly placed along the circumference of the rotation shaft 2.

A direction from the first stator 4 toward the rotor 3 is a lower part upward magnetization direction 38 as a first direction. The lower part upward magnetization direction 38 is the same direction as the upward direction 10. A lower part downward magnetization direction 39 is an opposite direction to the lower part upward magnetization direction 38. A rightward magnetization direction 41 is the same direction as the second circumferential direction 12. A leftward magnetization direction 42 is the same direction as the first circumferential direction 11. The rightward magnetization direction 41 and the leftward magnetization direction 42 are different directions from the lower part upward magnetization direction 38.

Arrows within the permanent magnet 14 show magnetization directions 43. The magnetization direction 43 of the lower part first upward main magnet 32 and the lower part second upward main magnet 34 is the lower part upward magnetization direction 38. A direction from the rotor 3 toward the first stator core 18 is the lower part downward magnetization direction 39. The magnetization direction 43 of the lower part first downward main magnet 33 and the lower part second downward main magnet 36 is the lower part downward magnetization direction 39. Themagnetization direction 43 of the lower part second rightward sub-magnet 35 is the rightward magnetization direction 41. The magnetization direction 43 of the lower part second leftward sub-magnet 37 is the leftward magnetization direction 42.

The permanent magnet 14 includes a plurality of the lower part first upward main magnets 32 and a plurality of the lower part second upward main magnets 34 having the magnetization direction 43 in the lower part upward magnetization direction 38. Further, the permanent magnet 14 includes a plurality of the lower part second rightward sub-magnets 35 having the magnetization direction 43 in the rightward magnetization direction 41 different from the lower part upward magnetization direction 38 and a plurality of the lower part second leftward sub-magnets 37 having the magnetization direction 43 in the leftward magnetization direction 42 different from the lower part upward magnetization direction 38. Furthermore, the permanent magnet 14 includes a plurality of the lower part first downward main magnets 33 and a plurality of the lower part second downward main magnets 36 having the magnetization direction 43 in the lower part downward magnetization direction 39.

A lower part main pole magnet 44 as the main pole magnet includes the lower part first upward main magnet 32 placed at the negative side in the lower part upward magnetization direction 38 and the lower part second upward main magnet 34 placed at the positive side in the lower part upward magnetization direction 38 and fixed to the frame 13. The lower part second rightward sub-magnet 35 and the lower part second upward main magnet 34 contact each other in a surface facing the circumferential direction 7 orthogonal to the lower part upward magnetization direction 38. The lower part second leftward sub-magnet 37 and the lower part second upward main magnet 34 contact each other in a surface facing the circumferential direction 7 orthogonal to the lower part upward magnetization direction 38. When the lower part permanent magnet 15 is seen along the lower part upward magnetization direction 38, the lower part first upward main magnet 32 and the lower part second rightward sub-magnet 35 partially overlap. Further, the lower part first upward main magnet 32 and the lower part second leftward sub-magnet 37 partially overlap. A part of the lower part first upward main magnet 32 and the lower part second upward main magnet 34 overlap.

According to the configuration, the lower part second rightward sub-magnet 35 and the lower part second leftward sub-magnet 37 and the lower part second upward main magnet 34 are placed adjoiningly in the circumferential directions 7. The lower part first upward main magnet 32 is placed at the negative side in the lower part upward magnetization direction 38 of the lower part second upward main magnet 34. When the lower part second upward main magnet 34 side is seen from the lower part first upward main magnet 32 side, the lower part first upward main magnet 32 and the lower part second rightward sub-magnet 35 overlap and the lower part first upward main magnet 32 and the lower part second leftward sub-magnet 37 overlap. The lower part first upward main magnet 32 projects toward the lower part second rightward sub-magnet 35 and lower part second leftward sub-magnet 37 sides over the lower part second upward main magnet 34 in the circumferential directions 7. In this regard, the distance between the adjacent lower part first upward main magnet 32 and lower part first downward main magnet 33 is shorter than the distance between the adjacent lower part second upward main magnet 34 and lower part second downward main magnet 36.

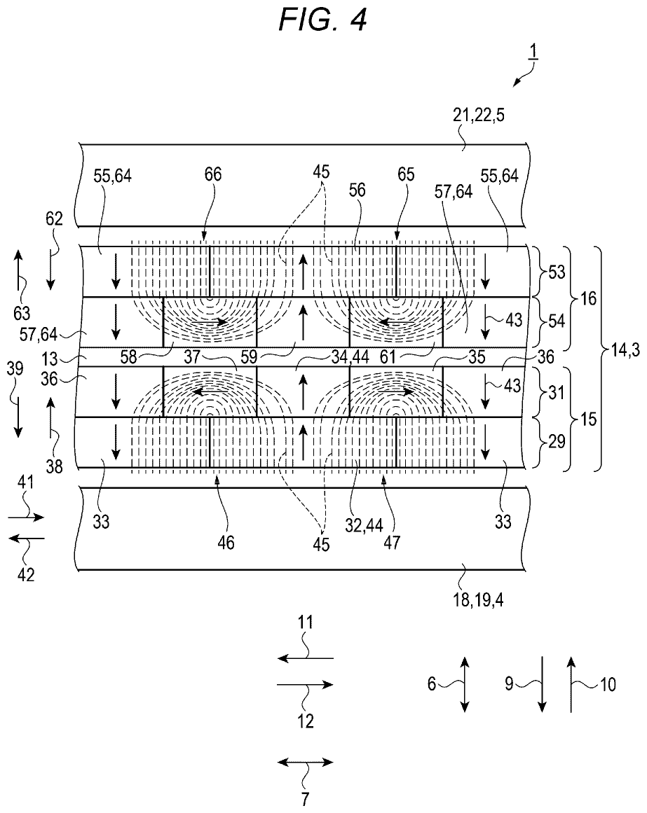

As shown in FIG. 4, when the distance between the adjacent lower part first upward main magnet 32 and lower part first downward main magnet 33 is shorter, the lower part first upward main magnet 32 may also pass many lines of magnetic force 45 through a first portion 46 as a portion located at the negative side in the lower part upward magnetization direction 38, i.e., an end portion in the first circumferential direction 11 and a second portion 47 as a portion located at the negative side in the lower part upward magnetization direction 38, i.e., an end portion in the second circumferential direction 12. That is, in a portion in which the lower part first upward main magnet 32 and the lower part second rightward sub-magnet 35 and lower part second leftward sub-magnet 37 overlap, lines of magnetic force flow from the lower part first upward main magnet 32 toward the lower part second rightward sub-magnet 35 and the lower part second leftward sub-magnet 37 and, in a portion in which the lower part first upward main magnet 32 and the lower part second upward main magnet 34 overlap, lines of magnetic force flow from the lower part first upward main magnet 32 toward the lower part second upward main magnet 34. Therefore, demagnetization of the first portion 46 and the second portion 47 of the lower part first upward main magnet 32 may be suppressed.

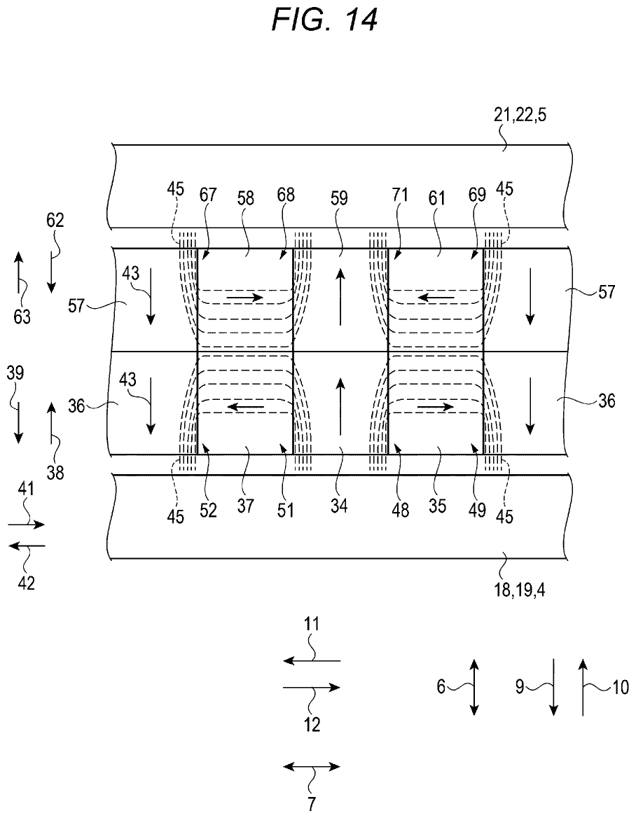

As an example of related art shown in FIG. 14, without the lower part first permanent magnet 29, in the lower part second rightward sub-magnet 35, magnetic flux density at the positive side in the lower part upward magnetization direction 38 is higher and magnetic flux density at the negative side in the lower part upward magnetization direction 38 is lower. Particularly, in the lower part second rightward sub-magnet 35, magnetic flux density is lower in a third portion 48 and a fourth portion 49 as end portions at both sides in the circumferential directions 7. In the portions with the lower magnetic flux density, the magnetization directions 43 easily become irregular when the portions are affected by magnetic flux and heat of the first stator 4 and the second stator 5. Therefore, magnetization is easily deteriorated in the third portion 48 and the fourth portion 49.

Similarly, in the lower part second leftward sub-magnet 37, magnetic flux density is lower in a sixth portion 51 and a seventh portion 52 as end portions at both sides in the circumferential directions 7. Therefore, magnetization is easily deteriorated in the sixth portion 51 and the seventh portion 52.

In the lower part permanent magnet 15 shown in FIG. 4, a portion with lower magnetic flux density is harder to be produced, and deterioration of magnetization of the lower part permanent magnet 15 may be suppressed.

The upper part permanent magnet 16 of the rotor 3 shown in FIG. 3 includes an upper part first permanent magnet 53 and an upper part second permanent magnet 54. The upper part first permanent magnet 53 is placed in the upward direction 10 of the upper part second permanent magnet 54.

The upper part first permanent magnet 53 includes an upper part first downward main magnet 55 as a main pole magnet and a first main pole magnet and an upper part first upward main magnet 56 as a first main pole magnet in contact with each other. The upper part first downward main magnet 55 and the upper part first upward main magnet 56 are sequentially repeatedly placed along the circumference of the rotation shaft 2.

The upper part second permanent magnet 54 includes an upper part second downward main magnet 57 as a main pole magnet and a second main pole magnet, an upper part second rightward sub-magnet 58 as a sub-pole magnet, an upper part second upward main magnet 59, and an upper part second leftward sub-magnet 61 as a sub-pole magnet in contact with each other. The upper part second downward main magnet 57, the upper part second rightward sub-magnet 58, the upper part second upward main magnet 59, and the upper part second leftward sub-magnet 61 are sequentially repeatedly placed along the circumference of the rotation shaft 2.

A direction from the second stator 5 toward the rotor 3 is an upper part downward magnetization direction 62 as a first direction. The upper part downward magnetization direction 62 is the same direction as the downward direction 9. An upper part upward magnetization direction 63 is an opposite direction to the upper part downward magnetization direction 62. The rightward magnetization direction 41 and the leftward magnetization direction 42 are different directions from the upper part downward magnetization direction 62.

The magnetization direction 43 of the upper part first downward main magnet 55 and the upper part second downward main magnet 57 is the upper part downward magnetization direction 62. A direction from the rotor 3 toward the second stator core 21 is the upper part upward magnetization direction 63. The magnetization direction 43 of the upper part first upward main magnet 56 and the upper part second upward main magnet 59 is the upper part upward magnetization direction 63. The magnetization direction 43 of the upper part second rightward sub-magnet 58 is the rightward magnetization direction 41. The magnetization direction 43 of the upper part second leftward sub-magnet 61 is the leftward magnetization direction 42.

The permanent magnet 14 includes a plurality of the upper part first downward main magnets 55 and a plurality of the upper part second downward main magnets 57 having the magnetization direction 43 in the upper part downward magnetization direction 62. Further, the permanent magnet 14 includes a plurality of the upper part second rightward sub-magnets 58 having the magnetization direction 43 in the rightward magnetization direction 41 different from the upper part downward magnetization direction 62 and a plurality of the upper part second leftward sub-magnets 61 having the magnetization direction 43 in the leftward magnetization direction 42 different from the upper part downward magnetization direction 62. Furthermore, the permanent magnet 14 includes a plurality of the upper part first upward main magnets 56 and a plurality of the upper part second upward main magnets 59 having the magnetization direction 43 in the upper part upward magnetization direction 63.

The upper part main pole magnet 64 as the main pole magnet includes the upper part first downward main magnet 55 placed at the negative side in the upper part downward magnetization direction 62 and the upper part second downward main magnet 57 placed at the positive side in the upper part downward magnetization direction 62 and fixed to the frame 13. The upper part second rightward sub-magnet 58 and the upper part second downward main magnet 57 contact each other in a surface facing the circumferential direction 7 orthogonal to the upper part downward magnetization direction 62. The upper part second leftward sub-magnet 61 and the upper part second downward main magnet 57 contact each other in a surface facing the circumferential direction 7 orthogonal to the upper part downward magnetization direction 62. When the upper part permanent magnet 16 is seen along the upper part downward magnetization direction 62, the upper part first downward main magnet 55 and the upper part second rightward sub-magnet 58 partially overlap. Further, the upper part first downward main magnet 55 and the upper part second leftward sub-magnet 61 partially overlap. A part of the upper part first downward main magnet 55 and the upper part second downward main magnet 57 overlap.

According to the configuration, the upper part first downward main magnet 55 projects toward the upper part second rightward sub-magnet 58 and upper part second leftward sub-magnet 61 sides over the upper part second downward main magnet 57 in the circumferential directions 7. In this regard, the distance between the adjacent upper part first downward main magnet 55 and upper part first upward main magnet 56 is shorter than the distance between the adjacent upper part second downward main magnet 57 and upper part second upward main magnet 59.

As shown in FIG. 4, when the distance between the adjacent upper part first downward main magnet 55 and the upper part first upward main magnet 56 is shorter, the upper part first downward main magnet 55 may pass the lines of magnetic force 45 through an eighth portion 65 as a portion located at the negative side in the upper part downward magnetization direction 62, i.e., an end portion in the first circumferential direction 11 and a ninth portion 66 as a portion located at the negative side in the upper part downward magnetization direction 62, i.e., an end portion in the second circumferential direction 12. Therefore, demagnetization of the eighth portion 65 and the ninth portion 66 of the upper part first downward main magnet 55 may be suppressed.

As an example of related art shown in FIG. 14, without the upper part first permanent magnet 53, in the upper part second rightward sub-magnet 58, magnetic flux density at the positive side in the upper part downward magnetization direction 62 is higher and magnetic flux density at the negative side in the upper part downward magnetization direction 62 is lower. Particularly, in the upper part second rightward sub-magnet 58, magnetic flux density is lower in a tenth portion 67 and an eleventh portion 68 as end portions at both sides in the circumferential directions 7. Therefore, magnetization is easily deteriorated in the tenth portion 67 and the eleventh portion 68.

Similarly, in the upper part second leftward sub-magnet 61, magnetic flux density is lower in a twelfth portion 69 and a thirteenth portion 71 at both sides in the circumferential directions 7. Therefore, magnetization is easily deteriorated in the twelfth portion 69 and the thirteenth portion 71.

In the upper part permanent magnet 16 shown in FIG. 4, a portion with lower magnetic flux density is harder to be produced, and deterioration of magnetization of the upper part permanent magnet 16 may be suppressed.

As shown in FIG. 3, the lower part second upward main magnet 34 has a first surface 34a as a surface fixed to the frame 13. The upper part second downward main magnet 57 has a second surface 57a as a surface fixed to the frame 13. According to the configuration, the lower part second upward main magnet 34 and the upper part second downward main magnet 57 may be easily fixed directly to the frame 13. No fixing member is placed between the lower part second upward main magnet 34 and the frame 13, and thereby, the length of the lower part main pole magnet 44 in the lower part upward magnetization direction 38 may be made longer. Accordingly, the magnetic force of the lower part main pole magnet 44 may be made stronger. Similarly, no fixing member is placed between the upper part second downward main magnet 57 and the frame 13, and thereby, the length of an upper part main pole magnet 64 in the upper part downward magnetization direction 62 may be made longer. Accordingly, the magnetic force of the upper part main pole magnet 64 may be made stronger.

The lower part second rightward sub-magnet 35 has a third surface 35a as a surface fixed to the frame 13. According to the configuration, the lower part second rightward sub-magnet 35 may be easily fixed to the frame 13. The lower part second leftward sub-magnet 37 has a fourth surface 37a as a surface fixed to the frame 13. According to the configuration, the lower part second leftward sub-magnet 37 may be easily fixed to the frame 13. The upper part second rightward sub-magnet 58 has a fifth surface 58a as a surface fixed to the frame 13. According to the configuration, the upper part second rightward sub-magnet 58 may be easily fixed to the frame 13. The upper part second leftward sub-magnet 61 has a sixth surface 61a as a surface fixed to the frame 13. According to the configuration, the upper part second leftward sub-magnet 61 may be easily fixed to the frame 13.

The adjacent lower part first upward main magnet 32 and lower part first downward main magnet 33 have a first end portion 32a as an end portion and a second end portion 33a as an end portion in contact with each other at the negative side in the lower part upward magnetization direction 38. Further, the adjacent lower part first upward main magnet 32 and lower part first downward main magnet 33 have a third end portion 32b as an end portion and a fourth end portion 34a as an end portion in contact with each other at the negative side in the lower part upward magnetization direction 38.

According to the configuration, the distance between the lower part first upward main magnet 32 and the lower part first downward main magnet 33 at the negative side in the lower part upward magnetization direction 38 may be made smaller. Therefore, demagnetization of the portions of the lower part first upward main magnet 32 and the lower part first downward main magnet 33 located at the negative side in the lower part upward magnetization direction 38, i.e., the portions at both ends in the circumferential directions 7 may be suppressed.

The adjacent upper part first downward main magnet 55 and upper part first upward main magnet 56 have a fifth end portion 55a as an end portion and a sixth end portion 56a as an end portion in contact with each other at the negative side in the upper part downward magnetization direction 62. Further, the adjacent upper part first downward main magnet 55 and upper part first upward main magnet 56 have a seventh end portion 55b as an end portion and an eighth end portion 56a as an end portion in contact with each other at the negative side in the upper part downward magnetization direction 62.

According to the configuration, the distance between the upper part first downward main magnet 55 and the upper part first upward main magnet 56 at the negative side in the upper part downward magnetization direction 62 may be made smaller. Therefore, demagnetization of the portions of the upper part first downward main magnet 55 and the upper part first upward main magnet 56 located at the negative side in the upper part downward magnetization direction 62, i.e., the portions at both ends in the circumferential directions 7 may be suppressed.

In the motor 1, the lower part upward magnetization direction 38 and the upper part downward magnetization direction 62 are the same directions as the axial directions 6 of the rotation shaft 2. According to the configuration, the motor 1 is the axial gap motor and the motor having the shorter length in the lower part upward magnetization direction 38 and the upper part downward magnetization direction 62 may be obtained.

Note that the motor 1 has the double-stator structure, however, the same effects may be obtained by a single-stator structure.

The magnets forming the permanent magnet 14 are magnetized in the respective single directions. The magnetization directions 43 of the respective magnets are the single directions, and the respective magnets may be magnetized by single magnetization. Therefore, the motor 1 may be manufactured with higher productivity.

In the lower part permanent magnet 15, the lower part second upward main magnet 34 is placed between the lower part second rightward sub-magnet 35 and the lower part second leftward sub-magnet 37. With the lower part second upward main magnet 34, the length of the lower part main pole magnet 44 including the lower part second upward main magnet 34 and the lower part first upward main magnet 32 may be made longer in the lower part upward magnetization direction 38. Accordingly, the magnetic force of the lower part main pole magnet 44 may be made stronger. Also, in the upper part permanent magnet 16, with the upper part second downward main magnet 57, the length of the upper part main pole magnet 64 including the upper part second downward main magnet 57 and the upper part first downward main magnet 55 may be made longer in the upper part downward magnetization direction 62. Accordingly, the magnetic force of the upper part main pole magnet 64 may be made stronger.

### Second Embodiment

The embodiment is different from the first embodiment in that the placement of the lower part first permanent magnet 29 and the upper part first permanent magnet 53 is different. The same configurations as those of the first embodiment have the same signs and the overlapping explanation will be omitted.

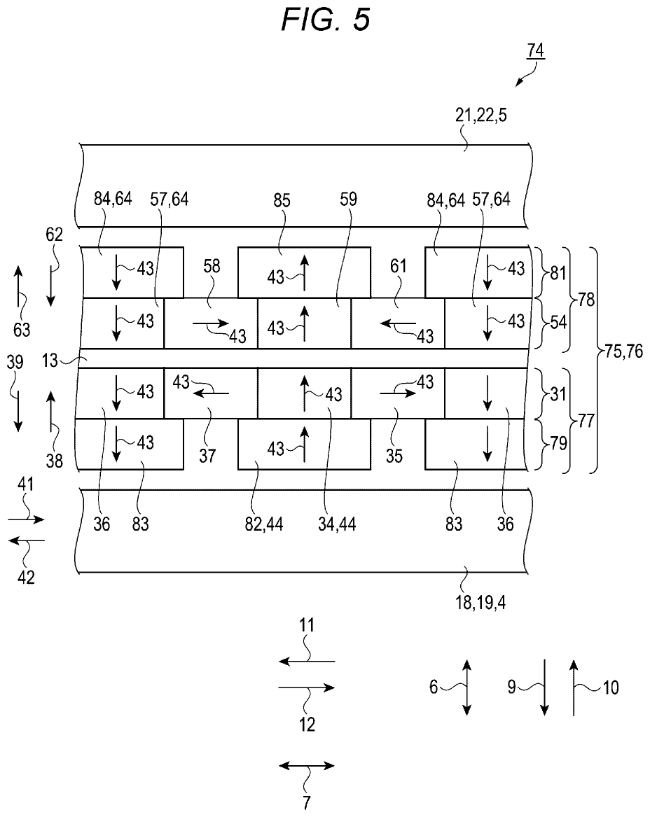

As shown in FIG. 5, a rotor 75 of a motor 74 as a rotary motor includes a permanent magnet 76 as a magnet. The permanent magnet 76 includes a lower part permanent magnet 77 and an upper part permanent magnet 78. The lower part permanent magnet 77 includes a lower part first permanent magnet 79 and the lower part second permanent magnet 31. The upper part permanent magnet 78 includes the upper part second permanent magnet 54 and an upper part first permanent magnet 81.

The lower part first permanent magnet 79 includes a lower part first upward main magnet 82 and a lower part first downward main magnet 83. The lower part first upward main magnet 82 and the lower part first downward main magnet 83 are placed apart. When the lower part permanent magnet 77 is seen from the lower part upward magnetization direction 38, the lower part first upward main magnet 82 and the lower part second upward main magnet 34 partially overlap, but not overlap in some region. In the configuration, there is no permanent magnet 76 between the lower part first upward main magnet 82 and the lower part first downward main magnet 83, and demagnetization may be suppressed.

The upper part first permanent magnet 81 includes an upper part first downward main magnet 84 and an upper part first upward main magnet 85. The upper part first downward main magnet 84 and the upper part first upward main magnet 85 are placed apart. When the upper part permanent magnet 78 is seen from the upper part downward magnetization direction 62, the upper part first downward main magnet 84 and the upper part second downward main magnet 57 partially overlap, but not overlap in some region. In the configuration, there is no permanent magnet 76 between the upper part first downward main magnet 84 and the upper part first upward main magnet 85, and demagnetization may be suppressed.

In the lower part permanent magnet 77, the lower part second upward main magnet 34 is placed between the lower part second rightward sub-magnet 35 and the lower part second leftward sub-magnet 37. With the lower part second upward main magnet 34, the length of the lower part main pole magnet 44 including the lower part second upward main magnet 34 and the lower part first upward main magnet 82 may be made longer in the lower part upward magnetization direction 38. Accordingly, the magnetic force of the lower part main pole magnet 44 may be made stronger. Also, in the upper part permanent magnet 78, with the upper part second downward main magnet 57, the length of the upper part main pole magnet 64 including the upper part second downward main magnet 57 and the upper part first downward main magnet 84 may be made longer in the upper part downward magnetization direction 62. Accordingly, the magnetic force of the upper part main pole magnet 64 may be made stronger.

### Third Embodiment

The embodiment is different from the first embodiment in that the lower part first permanent magnet 29 is thinner than the lower part second permanent magnet 31 and the upper part first permanent magnet 53 is thinner than the upper part second permanent magnet 54. The same configurations as those of the first embodiment have the same signs and the overlapping explanation will be omitted.

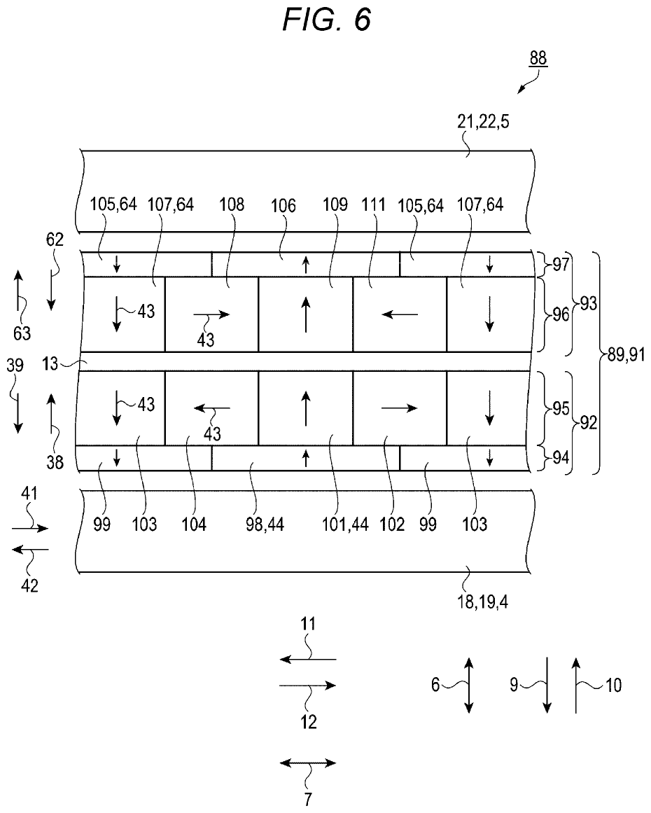

As shown in FIG. 6, a rotor 89 of a motor 88 as a rotary motor includes a permanent magnet 91 as a magnet. The permanent magnet 91 includes a lower part permanent magnet 92 and an upper part permanent magnet 93. The lower part permanent magnet 92 includes a lower part first permanent magnet 94 and a lower part second permanent magnet 95. The upper part permanent magnet 93 includes an upper part second permanent magnet 96 and an upper part first permanent magnet 97.

The lower part first permanent magnet 94 includes a lower part first upward main magnet 98 and a lower part first downward main magnet 99. The lower part second permanent magnet 95 includes a lower part second upward main magnet 101, a lower part second rightward sub-magnet 102, a lower part second downward main magnet 103, and a lower part second leftward sub-magnet 104. The lower part first permanent magnet 94 is thinner than the lower part second permanent magnet 95. In the configuration, the lower part first permanent magnet 94 is thinner, and thereby, demagnetization of the lower part first permanent magnet 94 may be suppressed.

The upper part first permanent magnet 97 includes an upper part first downward main magnet 105 and an upper part first upward main magnet 106. The upper part second main magnet 96 includes an upper part second downward main magnet 107, an upper part second rightward sub-magnet 108, an upper part second upward main magnet 109, and an upper part second leftward sub-magnet 111. The upper part first permanent magnet 97 is thinner than the upper part second permanent magnet 96. In the configuration, the upper part first permanent magnet 97 is thinner, and thereby, demagnetization of the upper part first permanent magnet 97 may be suppressed.

### Fourth Embodiment

The embodiment is different from the first embodiment in that members for positioning the respective magnets are provided. The same configurations as those of the first embodiment have the same signs and the overlapping explanation will be omitted.

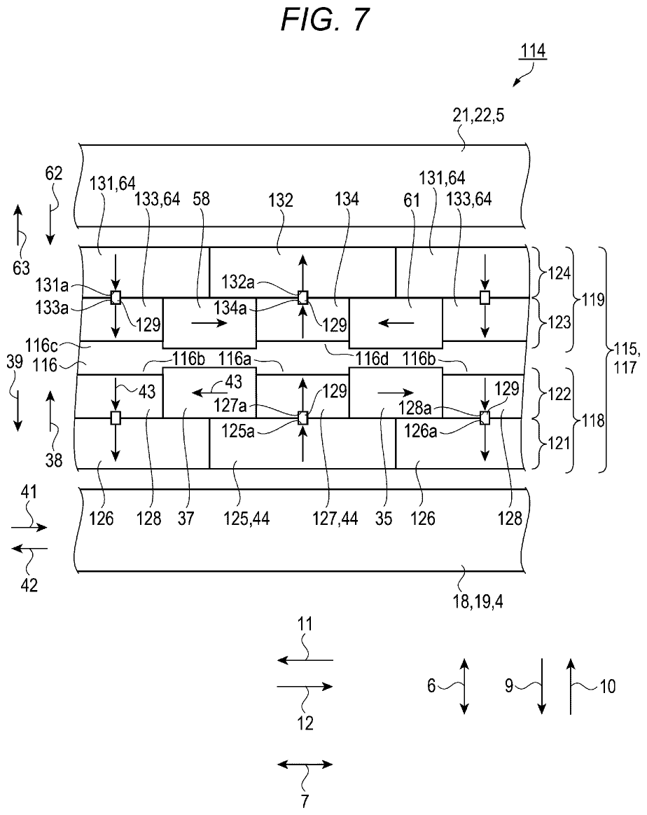

As shown in FIG. 7, a rotor 115 of a motor 114 as a rotary motor includes a frame 116 as a rotor frame and a permanent magnet 117 as a magnet. The permanent magnet 117 includes a lower part permanent magnet 118 and an upper part permanent magnet 119. The lower part permanent magnet 118 includes a lower part first permanent magnet 121 and a lower part second permanent magnet 122. The upper part permanent magnet 119 includes an upper part second permanent magnet 123 and an upper part first permanent magnet 124.

The lower part first permanent magnet 121 includes a lower part first upward main magnet 125 and a lower part first downward main magnet 126. The lower part second permanent magnet 122 includes a lower part second upward main magnet 127, the lower part second rightward sub-magnet 35, a lower part second downward main magnet 128, and the lower part second leftward sub-magnet 37.

The frame 116 has a first projection 116a as a projection in a location facing the lower part second upward main magnet 127. The frame 116 has a second projection 116b as a projection in a location facing the lower part second downward main magnet 128. The frame 116 has the first projection 116a and the second projection 116b, and the lower part second rightward sub-magnet 35 and the lower part second leftward sub-magnet 37 are fixed between the first projection 116a and the second projection 116b. Therefore, the frame 116 has the plurality of projections and the sub-pole magnets are fixed between the projections. According to the configuration, the lower part second rightward sub-magnet 35 and the lower part second leftward sub-magnet 37 may be easily placed with higher position accuracy with respect to the frame 116.

The lower part first upward main magnet 125 has a first hole 125a in a location facing the lower part second upward main magnet 127. The lower part second upward main magnet 127 has a second hole 127a in a location facing the first hole 125a. Positioning members 129 are inserted into the first hole 125a and the second hole 127a. The positioning members 129 have cylindrical shapes. According to the configuration, the lower part first upward main magnet 125 may be easily placed with higher position accuracy with respect to the lower part second upward main magnet 127.

The lower part first downward main magnet 126 has a third hole 126a in a location facing the lower part second downward main magnet 128. The lower part second downward main magnet 128 has a fourth hole 128a in a location facing the third hole 126a. The positioning members 129 are inserted into the third hole 126a and the fourth hole 128a. According to the configuration, the lower part first downward main magnet 126 may be easily placed with higher position accuracy with respect to the lower part second downward main magnet 128.

The upper part first permanent magnet 124 includes an upper part first downward main magnet 131 and an upper part first upward main magnet 132. The upper part second permanent magnet 123 includes an upper part second downward main magnet 133, the upper part second rightward sub-magnet 58, an upper part second upward main magnet 134, and the upper part second leftward sub-magnet 61.

The frame 116 has a third projection 116c as a projection in a location facing the upper part second downward main magnet 133. The frame 116 has a fourth projection 116d as a projection in a location facing the upper part second upward main magnet 134. The frame 116 has the third projection 116c and the fourth projection 116d, and the upper part second rightward sub-magnet 58 and the upper part second leftward sub-magnet 61 are fixed between the third projection 116c and the fourth projection 116d. Therefore, the frame 116 has the plurality of projections and the sub-pole magnets are fixed between the projections. According to the configuration, the upper part second rightward sub-magnet 58 and the upper part second leftward sub-magnet 61 may be easily placed with higher position accuracy with respect to the frame 116.

The upper part first downward main magnet 131 has a fifth hole 131a in a location facing the upper part second downward main magnet 133. The upper part second downward main magnet 133 has a sixth hole 133a in a location facing the fifth hole 131a. The positioning members 129 are inserted into the fifth hole 131a and the sixth hole 133a. The positioning members 129 have cylindrical shapes. According to the configuration, the upper part first downward main magnet 131 may be easily placed with higher position accuracy with respect to the upper part second downward main magnet 133.

The upper part first upward main magnet 132 has a seventh hole 132a in a location facing the upper part second upward main magnet 134. The upper part second upward main magnet 134 has an eighth hole 134a in a location facing the seventh hole 132a. The positioning members 129 are inserted into the seventh hole 132a and the eighth hole 134a. According to the configuration, the upper part first upward main magnet 132 may be easily placed with higher position accuracy with respect to the upper part second upward main magnet 134.

### Fifth Embodiment

The embodiment is different from the first embodiment in that concavities and convexities for positioning the respective magnets are provided. The same configurations as those of the first embodiment have the same signs and the overlapping explanation will be omitted.

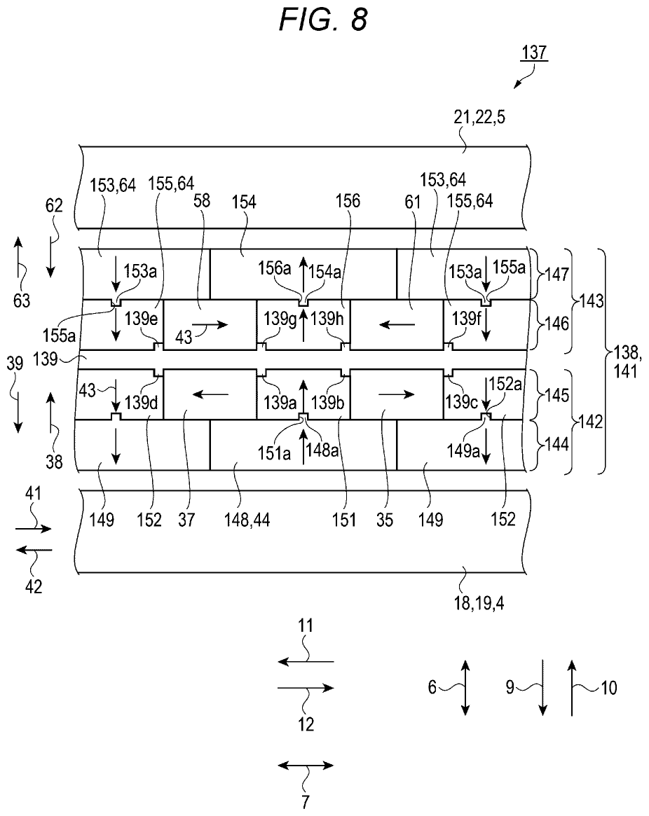

As shown in FIG. 8, a rotor 138 of a motor 137 as a rotary motor includes a frame 139 as a rotor frame and a permanent magnet 141 as a magnet. The permanent magnet 141 includes a lower part permanent magnet 142 and an upper part permanent magnet 143. The lower part permanent magnet 142 includes a lower part first permanent magnet 144 and a lower part second permanent magnet 145. The upper part permanent magnet 143 includes an upper part second permanent magnet 146 and an upper part first permanent magnet 147.

The lower part first permanent magnet 144 includes a lower part first upward main magnet 148 and a lower part first downward main magnet 149. The lower part second permanent magnet 145 includes a lower part second upward main magnet 151, the lower part second rightward sub-magnet 35, a lower part second downward main magnet 152, and the lower part second leftward sub-magnet 37.

The frame 139 has a first projection 139a as a projection and a second projection 139b as a projection in locations facing corners of the lower part second upward main magnet 151. The frame 139 has a third projection 139c as a projection and a fourth projection 139d as a projection in locations facing corners of the lower part second downward main magnet 152. The frame 139 has the second projection 139b and the third projection 139c, and the lower part second rightward sub-magnet 35 is fixed between the second projection 139b and the third projection 139c.

The frame 139 has the first projection 139a and the fourth projection 139d, and the lower part second leftward sub-magnet 37 is fixed between the first projection 139a and the fourth projection 139d. Therefore, the frame 139 has the plurality of projections and the sub-pole magnets are fixed between the projections. According to the configuration, the lower part second rightward sub-magnet 35 and the lower part second leftward sub-magnet 37 may be easily placed with higher position accuracy with respect to the frame 139.

The lower part first upward main magnet 148 has a first convex portion 148a in a location facing the lower part second upward main magnet 151. The lower part second upward main magnet 151 has a first hole 151a in a location facing the first convex portion 148a. The first convex portion 148a is inserted into the first hole 151a. According to the configuration, the lower part first upward main magnet 148 may be easily placed with higher position accuracy with respect to the lower part second upward main magnet 151.

The lower part first downward main magnet 149 has a second convex portion 149a in a location facing the lower part second downward main magnet 152. The lower part second downward main magnet 152 has a second hole 152a in a location facing the second convex portion 149a. The second convex portion 149a is inserted into the second hole 152a. According to the configuration, the lower part first downward main magnet 149 may be easily placed with higher position accuracy with respect to the lower part second downward main magnet 152.

The upper part first permanent magnet 147 includes an upper part first downward main magnet 153 and an upper part first upward main magnet 154. The upper part second permanent magnet 146 includes an upper part second downward main magnet 155, the upper part second rightward sub-magnet 58, an upper part second upward main magnet 156, and the upper part second leftward sub-magnet 61.

The frame 139 has a fifth projection 139e as a projection and a sixth projection 139f as a projection in corners of locations facing the upper part second downward main magnet 155. The frame 139 has a seventh projection 139g as a projection and an eighth projection 139h as a projection in corners of locations facing the upper part second upward main magnet 156. The frame 139 has the fifth projection 139e and the seventh projection 139g, and the upper part second rightward sub-magnet 58 is fixed between the fifth projection 139e and the seventh projection 139g.

The frame 139 has the eighth projection 139h and the sixth projection 139f, and the upper part second leftward sub-magnet 61 is fixed between the eighth projection 139h and the sixth projection 139f. Therefore, the frame 139 has the plurality of projections and the sub-pole magnets are fixed between the projections. According to the configuration, the upper part second rightward sub-magnet 58 and the upper part second leftward sub-magnet 61 may be easily placed with higher position accuracy with respect to the frame 139.

The upper part first downward main magnet 153 has a third convex portion 153a in a location facing the upper part second downward main magnet 155. The upper part second downward main magnet 155 has a first hole 155a in a location facing the third convex portion 153a. The third convex portion 153a is inserted into the first hole 155a. According to the configuration, the upper part first downward main magnet 153 may be easily placed with higher position accuracy with respect to the upper part second downward main magnet 155.

The upper part first upward main magnet 154 has a fourth convex portion 154a in a location facing the upper part second upward main magnet 156. The upper part second upward main magnet 156 has a second hole 156a in a location facing the fourth convex portion 154a. The fourth convex portion 154a is inserted into the second hole 156a. According to the configuration, the upper part first upward main magnet 154 may be easily placed with higher position accuracy with respect to the upper part second upward main magnet 156.

### Sixth Embodiment

The embodiment is different from the first embodiment in that the lower part second rightward sub-magnet 35, the lower part second leftward sub-magnet 37, the upper part second rightward sub-magnet 58, and the upper part second leftward sub-magnet 61 are respectively divided into twos. The same configurations as those of the first embodiment have the same signs and the overlapping explanation will be omitted.

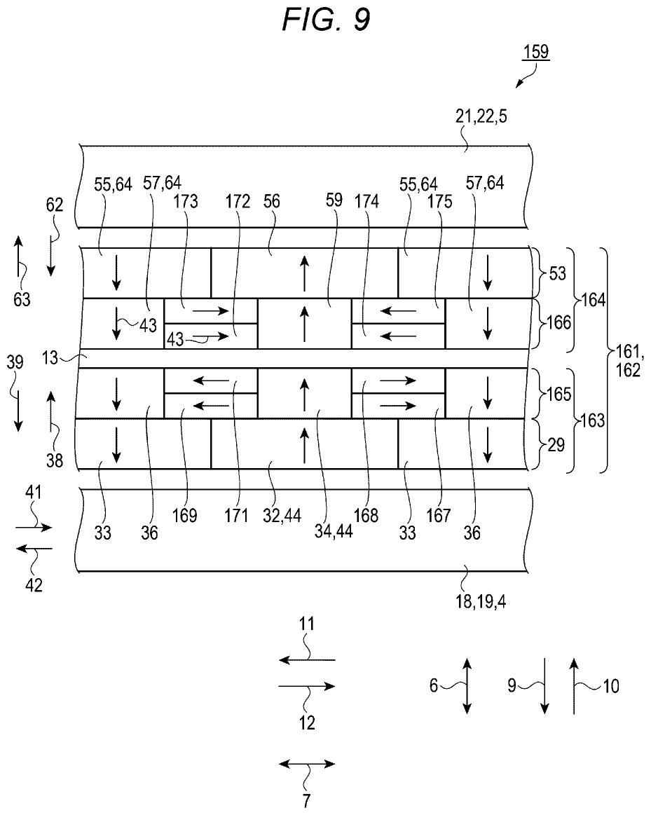

As shown in FIG. 9, a rotor 161 of a motor 159 as a rotary motor includes the frame 13 and a permanent magnet 162 as a magnet. The permanent magnet 162 includes a lower part permanent magnet 163 and an upper part permanent magnet 164. The lower part permanent magnet 163 includes the lower part first permanent magnet 29 and a lower part second permanent magnet 165. The upper part permanent magnet 164 includes an upper part second permanent magnet 166 and the upper part first permanent magnet 53.

The lower part second permanent magnet 165 includes the lower part second upward main magnet 34, a lower part second rightward lower sub-magnet 167, a lower part second rightward upper sub-magnet 168, the lower part second downward main magnet 36, a lower part second leftward lower sub-magnet 169, and a lower part second leftward upper sub-magnet 171.

The lower part second rightward upper sub-magnet 168 is placed to overlap with the lower part second rightward lower sub-magnet 167 in the upward direction 10. The lower part second rightward upper sub-magnet 168 and the lower part second rightward lower sub-magnet 167 are placed between the lower part second upward main magnet 34 and the lower part second downward main magnet 36.

The lower part second leftward upper sub-magnet 171 is placed to overlap with the lower part second leftward lower sub-magnet 169 in the upward direction 10. The lower part second leftward upper sub-magnet 171 and the lower part second leftward lower sub-magnet 169 are placed between the lower part second downward main magnet 36 and the lower part second upward main magnet 34.

The lower part second rightward lower sub-magnet 167 and the lower part second rightward upper sub-magnet 168 are longer and thinner than the lower part second rightward sub-magnet 35 of the first embodiment and a diamagnetic field is hard to be applied thereto, and thereby, demagnetization may be made harder. The lower part second leftward lower sub-magnet 169 and the lower part second leftward upper sub-magnet 171 are longer and thinner than the lower part second leftward sub-magnet 37 of the first embodiment and a diamagnetic field is hard to be applied thereto, and thereby, demagnetization may be made harder.

The upper part second permanent magnet 166 includes the upper part second downward main magnet 57, an upper part second rightward lower sub-magnet 172, an upper part second rightward upper sub-magnet 173, the upper part second upward main magnet 59, an upper part second leftward lower sub-magnet 174, and an upper part second leftward upper sub-magnet 175.

The upper part second rightward upper sub-magnet 173 is placed to overlap with the upper part second rightward lower sub-magnet 172 in the upward direction 10. The upper part second rightward upper sub-magnet 173 and the upper part second rightward lower sub-magnet 172 are placed between the upper part second downward main magnet 57 and the upper part second upward main magnet 59.

The upper part second leftward upper sub-magnet 175 is placed to overlap with the upper part second leftward lower sub-magnet 174 in the upward direction 10. The upper part second leftward upper sub-magnet 175 and the upper part second leftward lower sub-magnet 174 are placed between the upper part second upward main magnet 59 and the upper part second downward main magnet 57.

The upper part second rightward lower sub-magnet 172 and the upper part second rightward upper sub-magnet 173 are longer and thinner than the upper part second rightward sub-magnet 58 of the first embodiment and a diamagnetic field is hard to be applied thereto, and thereby, demagnetization may be made harder. The upper part second leftward lower sub-magnet 174 and the upper part second leftward upper sub-magnet 175 are longer and thinner than the upper part second leftward sub-magnet 61 of the first embodiment and a diamagnetic field is hard to be applied thereto, and thereby, demagnetization may be made harder.

### Seventh Embodiment

The embodiment is different from the first embodiment in that, when the permanent magnet 14 is seen from the opposite direction to the radial direction 8, an upward main magnet, a leftward sub-magnet, a downward main magnet, and a rightward sub-magnet respectively have triangular shapes and arranged in this order. The same configurations as those of the first embodiment have the same signs and the overlapping explanation will be omitted.

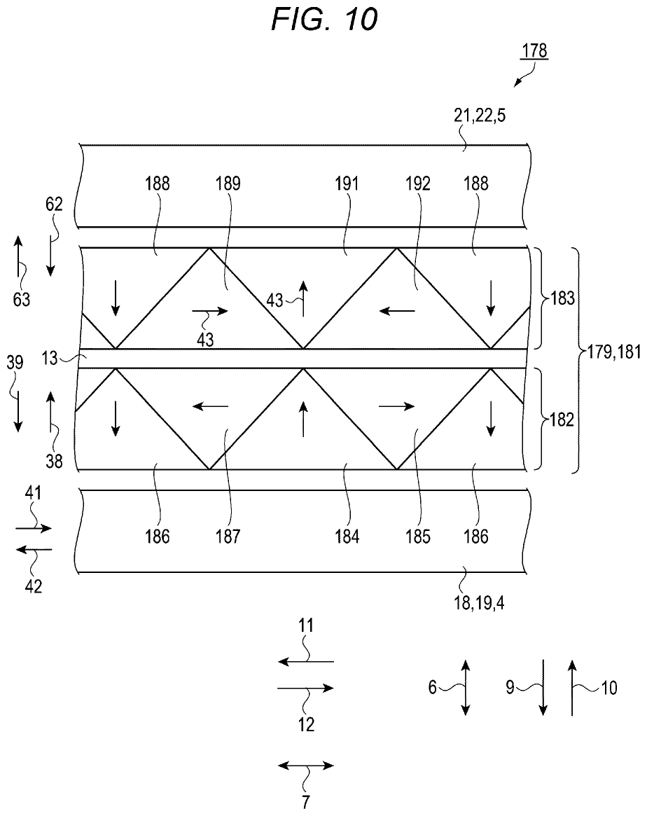

As shown in FIG. 10, a rotor 179 of a motor 178 as a rotary motor includes the frame 13 and a permanent magnet 181 as a magnet. The permanent magnet 181 includes a lower part permanent magnet 182 and an upper part permanent magnet 183. In the lower part permanent magnet 182, a lower part upward main magnet 184, a lower part rightward sub-magnet 185, a lower part downward main magnet 186, and a lower part leftward sub-magnet 187 are circularly arranged in the order. The shapes of the lower part upward main magnet 184, the lower part rightward sub-magnet 185, the lower part downward main magnet 186, and the lower part leftward sub-magnet 187 as seen from the opposite direction to the radial direction 8 are triangular shapes. One sides of the triangular shapes of the lower part upward main magnet 184 and the lower part downward main magnet 186 face the first stator 4. One sides of the triangular shapes of the lower part rightward sub-magnet 185 and the lower part leftward sub-magnet 187 are fixed to the frame 13.

The corners at the first stator 4 side of the lower part upward main magnet 184 and the lower part downward main magnet 186 are close to each other. The lengths of the lower part rightward sub-magnet 185 and the lower part leftward sub-magnet 187 in the circumferential directions 7 are shorter as the sub-magnets are closer to the first stator 4. Accordingly, demagnetization of the lower part rightward sub-magnet 185 and the lower part leftward sub-magnet 187 may be suppressed.

In the upper part permanent magnet 183, an upper part downward main magnet 188, an upper part rightward sub-magnet 189, an upper part upward main magnet 191, and an upper part leftward sub-magnet 192 are circularly arranged in the order. The shapes of the upper part downward main magnet 188, the upper part rightward sub-magnet 189, the upper part upward main magnet 191, and the upper part leftward sub-magnet 192 as seen from the opposite direction to the radial direction 8 are triangular shapes. One sides of the triangular shapes of the upper part downward main magnet 188 and the upper part upward main magnet 191 face the second stator 5. One sides of the triangular shapes of the upper part rightward sub-magnet 189 and the upper part leftward sub-magnet 192 are fixed to the frame 13.

The corners at the second stator 5 side of the upper part downward main magnet 188 and the upper part upward main magnet 191 are close to each other. The lengths of the upper part rightward sub-magnet 189 and the upper part leftward sub-magnet 192 in the circumferential directions 7 are shorter as the sub-magnets are closer to the second stator 5. Accordingly, demagnetization of the upper part rightward sub-magnet 189 and the upper part leftward sub-magnet 192 may be suppressed.

### Eighth Embodiment

The embodiment is different from the first embodiment in that the motor is a radial gap motor. The same configurations as those of the first embodiment have the same signs and the overlapping explanation will be omitted.

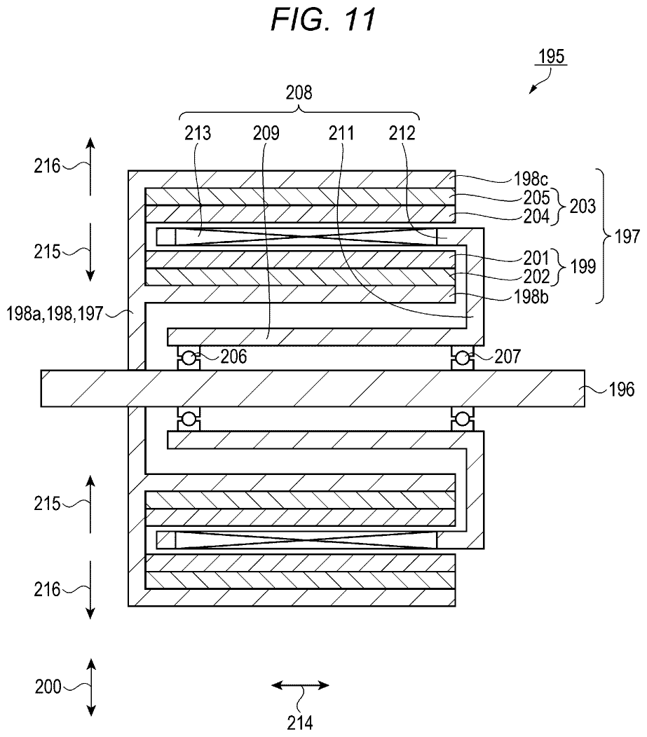

As shown in FIG. 11, a motor 195 as a rotary motor includes a rotation shaft 196. A rotor 197 is fixed to the rotation shaft 196. The rotor 197 rotates with the rotation shaft 196. The rotor 197 includes a frame 198 as a rotor frame. The frame 198 includes a supporting portion 198a, an inner frame 198b as a rotor frame, and an outer frame 198c as a rotor frame. The supporting portion 198a has a disc shape and extends in radial directions 200 of the rotation shaft 196. The supporting portion 198a supports the inner frame 198b and the outer frame 198c. The inner frame 198b and the outer frame 198c respectively have cylindrical shapes. The inner frame 198b and the outer frame 198c are placed coaxially with the rotation shaft 196. The inner frame 198b is placed closer to the rotation shaft 196 than the outer frame 198c. One ends of the inner frame 198b and the outer frame 198c are fixed to the supporting portion 198a. The inner frame 198b and the outer frame 198c are coupled to the rotation shaft 196 via the supporting portion 198a.

An inner magnet 199 as a magnet is fixed at the outer circumferential side of the inner frame 198b. The inner magnet 199 includes an inner first magnet 201 and an inner second magnet 202. The inner first magnet 201 and the inner second magnet 202 have cylindrical shapes and are placed coaxially with the rotation shaft 196. The inner second magnet 202 is fixed to the inner frame 198b. The inner first magnet 201 is placed to overlap with the inner second magnet 202.

An outer magnet 203 as a magnet is fixed at the inner circumferential side of the outer frame 198c. The outer magnet 203 includes an outer first magnet 204 and an outer second magnet 205. The outer first magnet 204 and the outer second magnet 205 have cylindrical shapes and are placed coaxially with the rotation shaft 196. The outer second magnet 205 is fixed to the outer frame 198c. The outer first magnet 204 is placed to overlap with the outer second magnet 205. The inner magnet 199 and the outer magnet 203 rotate with the rotation shaft 196.

Inner rings of a first bearing 206 and a second bearing 207 are placed on the rotation shaft 196. A stator 208 is placed on outer rings of the first bearing 206 and the second bearing 207. The rotor 197 rotates relative to the stator 208. The stator 208 includes an axial supporting portion 209, an intermediate supporting portion 211, and a coil supporting portion 212.

The axial supporting portion 209 and the coil supporting portion 212 have cylindrical shapes and are placed coaxially with the rotation shaft 196. The axial supporting portion 209 is placed on the outer rings of the first bearing 206 and the second bearing 207. The intermediate supporting portion 211 has a disc shape and extends in the radial directions 200 of the rotation shaft 196. The intermediate supporting portion 211 is coupled to the axial supporting portion 209 and the coil supporting portion 212.

A coil 213 is placed in the coil supporting portion 212. Therefore, the stator 208 includes the coil 213. The coil 213 is placed with gaps between the inner magnet 199 and the outer magnet 203. Therefore, the rotor 197 is placed with gaps between the coil 213 and itself. The rotor 197 rotates relative to the stator 208. Directions along the rotation shaft 196 are axial directions 214.

A direction from the stator 208 of the part with the coil 213 toward the inner magnet 199 is an inner first direction 215 as a first direction. The inner magnet 199 is a part of the rotor 197, and the inner first direction 215 is a direction from the stator 208 toward the rotor 197 in the relationship between the stator 208 of the part with the coil 213 and the inner magnet 199.

A direction from the stator 208 of the part with the coil 213 toward the outer magnet 203 is an outer first direction 216 as a first direction. The outer magnet 203 is a part of the rotor 197, and the outer first direction 216 is a direction from the stator 208 toward the rotor 197 in the relationship between the stator 208 of the part with the coil 213 and the outer magnet 203. The inner first direction 215 and the outer first direction 216 are opposite to each other.

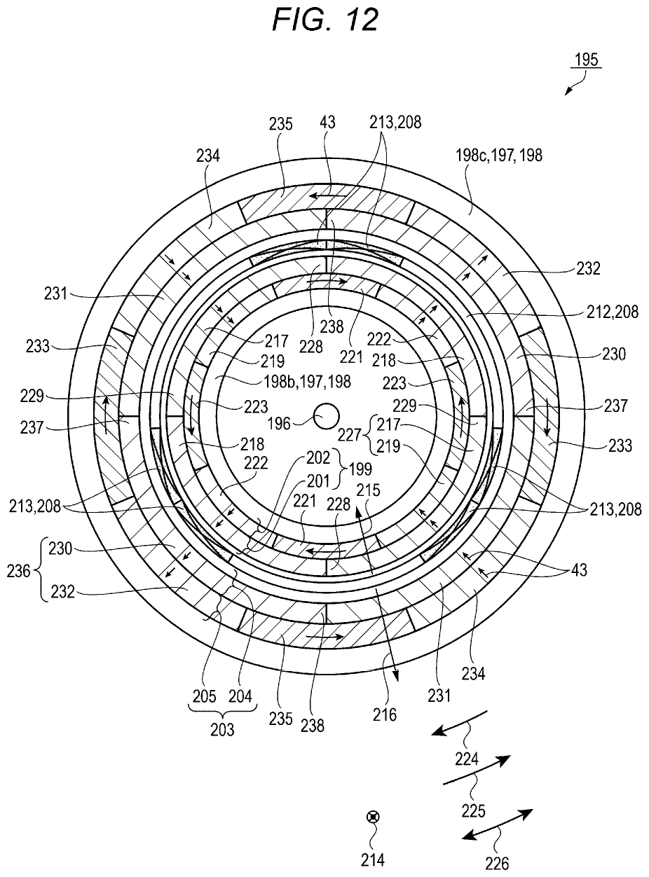

FIG. 12 shows the inner magnet 199, the outer magnet 203, and the coil 213 as seen from the axial directions 214. As shown in FIG. 12, the inner magnet 199 and the outer magnet 203 of the rotor 197 are placed in Halbach magnet arrays.

The inner first magnet 201 includes an inner first inward main magnet 217 as a main pole magnet and a first main pole magnet and an inner first outward main magnet 218 as a first main pole magnet in contact with each other. The inner first inward main magnet 217 and the inner first outward main magnet 218 are sequentially repeatedly placed along the circumference of the rotation shaft 196.

The inner second magnet 202 includes an inner second inward main magnet 219 as a main pole magnet and a second main pole magnet, an inner second rightward sub-magnet 221 as a sub-pole magnet, an inner second outward main magnet 222, and an inner second leftward sub-magnet 223 as a sub-pole magnet in contact with each other. The inner second inward main magnet 219, the inner second rightward sub-magnet 221, the inner second outward main magnet 222, and the inner second leftward sub-magnet 223 are sequentially repeatedly placed along the circumference of the rotation shaft 196.

Arrows within the inner magnet 199 and the outer magnet 203 show the magnetization directions 43. The magnetization direction 43 of the inner first inward main magnet 217 and the inner second inward main magnet 219 is the inner first direction 215. The magnetization direction 43 of the inner first outward main magnet 218 and the inner second outward main magnet 222 is the opposite direction to the inner first direction 215.

In FIG. 12, a right-handed rotation 224 is a clockwise direction. A left-handed rotation 225 is a counter-clockwise direction. Directions including both the right-handed rotation 224 and the left-handed rotation 225 are circumferential directions 226 as second directions. The circumferential directions 226 are different from the inner first direction 215 and the outer first direction 216.

The inner magnet 199 includes a plurality of the inner first inward main magnets 217 and a plurality of the inner second inward main magnets 219 having the magnetization direction 43 in the inner first direction 215. Further, the inner magnet 199 includes a plurality of the inner second rightward sub-magnets 221 having the magnetization direction 43 in the right-handed rotation 224 different from the inner first direction 215 and a plurality of the inner second leftward sub-magnets 223 having the magnetization direction 43 in the left-handed rotation 225 different from the inner first direction 215. Furthermore, the inner magnet 199 includes a plurality of the inner first outward main magnets 218 and a plurality of the inner second outward main magnets 222 having the magnetization direction 43 in the opposite direction to the inner first direction 215.

An inner main-pole magnet 227 as a main pole magnet includes the inner first inward main magnet 217 placed at the negative side in the inner first direction 215 and the inner second inward main magnet 219 placed at the positive side in the inner first direction 215 and fixed to the frame 198. The inner second rightward sub-magnet 221 and the inner second inward main magnet 219 contact each other in a surface facing the circumferential direction 226 orthogonal to the inner first direction 215. The inner second leftward sub-magnet 223 and the inner second inward main magnet 219 contact each other in a surface facing the circumferential direction 226 orthogonal to the inner first direction 215. When the inner magnet 199 is seen along the inner first direction 215, the inner first inward main magnet 217 and a part of the inner second rightward sub-magnet 221 overlap. Further, the inner first inward main magnet 217 and a part of the inner second leftward sub-magnet 223 overlap. A part of the inner first inward main magnet 217 and the inner second inward main magnet 219 overlap.

According to the configuration, the inner first inward main magnet 217 projects toward the inner second rightward sub-magnet 221 and inner second leftward sub-magnet 223 sides over the inner second inward main magnet 219 in the circumferential directions 226. In this regard, the distance between the adjacent inner first inward main magnet 217 and inner first outward main magnet 218 is shorter than the distance between the inner second inward main magnet 219 and the inner second outward main magnet 222 adjacent with the inner second rightward sub-magnet 221 or the inner second leftward sub-magnet 223 in between.

Here, the inner first inward main magnet 217 may also pass the lines of magnetic force 45 through a portion located at the negative side in the inner first direction 215 at an end in the right-handed rotation 224 and a portion located at the negative side in the inner first direction 215 at an end in the left-handed rotation 225. Therefore, demagnetization of a first portion 228 and a second portion 229 of the inner first inward main magnet 217 may be suppressed. In the inner magnet 199, a portion with lower magnetic flux density is harder to be produced, and deterioration of magnetization of the inner magnet 199 may be suppressed.

The outer first magnet 204 includes an outer first outward main magnet 230 as a main pole magnet and a first main pole magnet and an outer first inward main magnet 231 as a first main pole magnet in contact with each other. The outer first outward main magnet 230 and the outer first inward main magnet 231 are sequentially repeatedly placed along the circumference of the rotation shaft 196.

The outer second magnet 205 includes an outer second outward main magnet 232 as a main pole magnet and a second main pole magnet, an outer second rightward sub-magnet 233 as a sub-pole magnet, an outer second inward main magnet 234, and an outer second leftward sub-magnet 235 as a sub-pole magnet in contact with each other. The outer second outward main magnet 232, the outer second rightward sub-magnet 233, the outer second inward main magnet 234, and the outer second leftward sub-magnet 235 are sequentially repeatedly placed along the circumference of the rotation shaft 196.

The magnetization direction 43 of the outer first outward main magnet 230 and the outer second outward main magnet 232 is the outer first direction 216. The magnetization direction 43 of the outer first inward main magnet 231 and the outer second inward main magnet 234 is the opposite direction to the outer first direction 216.

The outer magnet 203 includes a plurality of the outer first outward main magnets 230 and a plurality of the outer second outward main magnets 232 having the magnetization direction 43 in the outer first direction 216. Further, the outer magnet 203 includes a plurality of the outer second rightward sub-magnets 233 having the magnetization direction 43 in the right-handed rotation 224 different from the outer first direction 216 and a plurality of the outer second leftward sub-magnets 235 having the magnetization direction 43 in the left-handed rotation 225 different from the outer first direction 216. Furthermore, the outer magnet 203 includes a plurality of the outer first inward main magnets 231 and a plurality of the outer second inward main magnets 234 having the magnetization direction 43 in the opposite direction to the outer first direction 216.

An outer main pole magnet 236 as a main pole magnet includes the outer first outward main magnet 230 placed at the negative side in the outer first direction 216 and the outer second outward main magnet 232 placed at the positive side in the outer first direction 216 and fixed to the frame 198. The outer second rightward sub-magnet 233 and the outer second outward main magnet 232 contact each other in a surface facing the circumferential direction 226 orthogonal to the outer first direction 216. The outer second leftward sub-magnet 235 and the outer second outward main magnet 232 contact each other in a surface facing the circumferential direction 226 orthogonal to the outer first direction 216. When the outer magnet 203 is seen along the outer first direction 216, the outer first outward main magnet 230 and a part of the outer second rightward sub-magnets 233 overlap. Further, the outer first outward main magnet 230 and a part of the outer second leftward sub-magnet 235 overlap. A part of the outer first outward main magnet 230 and the outer second outward main magnet 232 overlap.

According to the configuration, the outer first outward main magnet 230 projects toward the outer second rightward sub-magnet 233 and outer second leftward sub-magnet 235 sides over the outer second outward main magnet 232 in the circumferential directions 226. In this regard, the distance between the adjacent outer first outward main magnet 230 and outer first inward main magnet 231 is shorter than the distance between the outer second outward main magnets 232 and the outer second inward main magnet 234 with the outer second rightward sub-magnet 233 or the outer second leftward sub-magnet 235 in between.

Here, the outer first outward main magnet 230 may pass the lines of magnetic force 45 through a portion located at the negative side in the outer first direction 216 at an end in the right-handed rotation 224 and a portion located at the negative side in the outer first direction 216 at an end in the left-handed rotation 225. Therefore, demagnetization of a third portion 237 and a fourth portion 238 of the outer first outward main magnet 230 may be suppressed. In the outer magnet 203, a portion with lower magnetic flux density is harder to be produced, and deterioration of magnetization of the outer magnet 203 may be suppressed.

In the motor 195, the inner first direction 215 and the outer first direction 216 are orthogonal to the axial direction 214 of the rotation shaft 196. According to the configuration, the motor 195 is the radial gap motor, and a rotary motor having a shorter radial length may be obtained.

### Ninth Embodiment

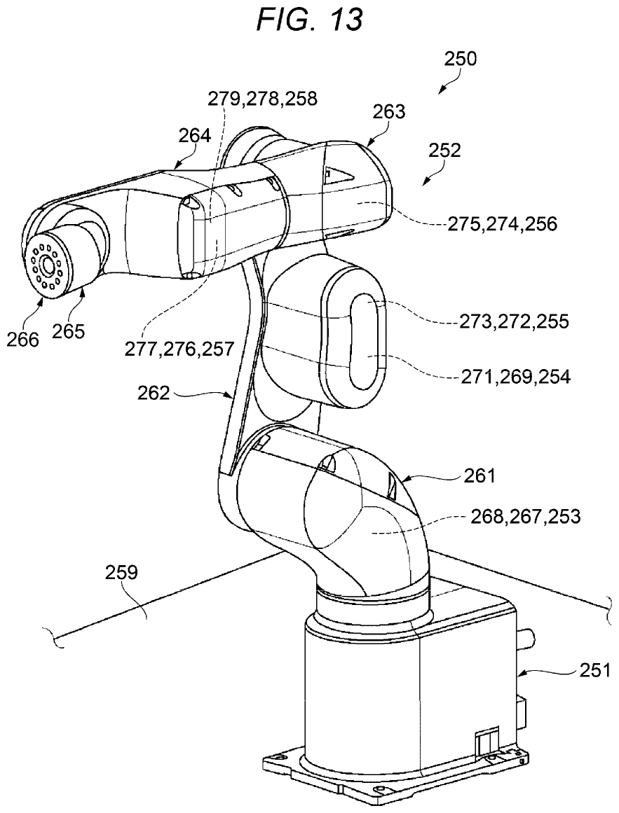

In the embodiment, a robot including the motor described in the first embodiment to the eighth embodiment will be explained. A robot 250 shown in FIG. 13 is used for respective work of e.g. transport, assembly, inspection, etc. of various workpieces as objects. The robot 250 has a base 251, a robot arm 252, and first drive unit 253 to sixth drive unit 258. The base 251 is mounted on a horizontal floor 259. Note that the base 251 may be mounted not on the floor 259, but on a wall, a ceiling, a platform, or the like.

The robot arm 252 includes a first arm 261, a second arm 262, a third arm 263, a fourth arm 264, a fifth arm 265, and a sixth arm 266. An end effector (not shown) may be detachably attached to the distal end of the sixth arm 266. For example, the end effector grips a workpiece. The workpiece gripped by the end effector is not particularly limited to, but includes e.g. an electronic component and an electronic apparatus. In this specification, the base 251 side with reference to the sixth arm 266 is referred to as “proximal end side” and the sixth arm 266 side with reference to the base 251 is referred to as “distal end side”. The end effector is not particularly limited to, but includes a hand gripping a workpiece and a suction head suctioning a workpiece.

The robot 250 is a single-arm six-axis vertical articulated robot in which the base 251, the first arm 261, the second arm 262, the third arm 263, the fourth arm 264, the fifth arm 265, and the sixth arm 266 are sequentially coupled from the proximal end side toward the distal end side. Hereinafter, the first arm 261, the second arm 262, the third arm 263, the fourth arm 264, the fifth arm 265, and the sixth arm 266 are also respectively referred to as “arm”. The lengths of the first arm 261 to the sixth arm 266 are respectively not particularly limited, but can be appropriately set. Note that the number of arms of the robot arm 252 may be one to five, seven, or more. Or, the robot 250 may be a scalar robot or a dual-arm robot including two or more robot arms 252.

The base 251 and the first arm 261 are coupled via a first joint 267. The first arm 261 is pivotable around a pivot axis parallel to a vertical axis as a pivot center relative to the base 251. The first arm 261 pivots by driving of a first motor 268 and the first drive unit 253 having a reducer (not shown). The first motor 268 generates a drive force for pivoting the first arm 261.

The first arm 261 and the second arm 262 are coupled via a second joint 269. The second arm 262 is pivotable around a pivot axis parallel to a horizontal plane as a pivot center relative to the first arm 261. The second arm 262 pivots by driving of a second motor 271 and the second drive unit 254 having a reducer (not shown). The second motor 271 generates a drive force for pivoting the second arm 262.

The second arm 262 and the third arm 263 are coupled via a third joint 272. The third arm 263 is pivotable around an axis parallel to a horizontal plane as a pivot center relative to the second arm 262. The third arm 263 pivots by driving of a third motor 273 and the third drive unit 255 having a reducer (not shown). The third motor 273 generates a drive force for pivoting the third arm 263.

The third arm 263 and the fourth arm 264 are coupled via a fourth joint 274. The fourth arm 264 is pivotable around a pivot axis parallel to a center axis of the third arm 263 as a pivot center relative to the third arm 263. The fourth arm 264 pivots by driving of a fourth motor 275 and the fourth drive unit 256 having a reducer (not shown). The fourth motor 275 generates a drive force for pivoting the fourth arm 264.

The fourth arm 264 and the fifth arm 265 are coupled via a fifth joint 276. The fifth arm 265 is pivotable around a pivot axis orthogonal to a center axis of the fourth arm 264 as a pivot center relative to the fourth arm 264. The fifth arm 265 pivots by driving of a fifth motor 277 and the fifth drive unit 257 having a reducer (not shown). The fifth motor 277 generates a drive force for pivoting the fifth arm 265.

The fifth arm 265 and the sixth arm 266 are coupled via a sixth joint 278. The sixth arm 266 is pivotable around a pivot axis parallel to a center axis in the distal end portion of the fifth arm 265 as a pivot center relative to the fifth arm 265. The sixth arm 266 pivots by driving of a sixth motor 279 and the sixth drive unit 258 having a reducer (not shown). The sixth motor 279 generates a drive force for pivoting the sixth arm 266.

The motor according to the above described respective embodiments is used for at least one of the first motor 268 to the sixth motor 279. That is, the robot 250 includes the motor according to the above described respective embodiments.

According to the configuration, the first motor 268 to the sixth motor 279 of the robot arm 252 are rotary motors in which demagnetization of the main pole magnets may be suppressed. Therefore, the robot arm 252 may be a robot arm including motors in which demagnetization of the main pole magnets may be suppressed.

The rotation shaft of at least one of these first motor 268 to sixth motor 279 has the through hole 2b extending in the axial directions 6 shown in the first embodiment, the electric wires 28 are inserted through the through hole 2b. According to the configuration, the through hole 2b of the rotation shaft 2 serves as a route for the electric wires 28. Therefore, the electric wires 28 may be placed at the inside between the rotating members, and breaking of the electric wires 28 may be prevented.

### Tenth Embodiment

The motor 195 of the eighth embodiment is in a form of a radial gap motor of the motor 1 of the first embodiment. In addition, the motor 74 of the second embodiment to the motor 178 of the seventh embodiment may be changed into forms of radial gap motors. Also, in this case, the same effects as those of the respective embodiments may be obtained.

### Eleventh Embodiment

In the motor 1 of the first embodiment, the first coil 19 is wound around the first stator core 18 and the second coil 22 is wound around the second stator core 21. The stator may be coreless. Cogging may be reduced.

### Twelfth Embodiment

In the ninth embodiment, the example using the rotary motors according to the above described respective embodiments for the first motor 268 to sixth motor 279 of the six-axis vertical articulated robot is shown. In addition, the first motor 268 to sixth motor 279 may be applied to an apparatus including a motor such as a scalar robot, a machine tool, an automobile, an electric railcar, or a home appliance.

What is claimed is:

1. A rotary motor comprising:
a stator including a coil; and
a rotor placed with a gap between the coil and itself and rotating relative to the stator, wherein
the rotor includes
a rotor frame coupled to a rotation shaft, and
a magnet fixed to the rotor frame,
with a direction from the stator to the rotor as a first direction, the magnet includes a plurality of main pole magnets having a magnetization direction in the first direction and a plurality of sub-pole magnets having a magnetization direction in a direction different from the first direction,
the main pole magnet includes a first main pole magnet placed at a negative side in the first direction and a second main pole magnet placed at a positive side in the first direction and fixed to the rotor frame,
the sub-pole magnet and the second main pole magnet contact each other in a surface facing a second direction orthogonal to the first direction,
when the magnet is seen along the first direction, a part of the first main pole magnet and the sub-pole magnet overlap and a part of the first main pole magnet and the second main pole magnet overlap.

2. The rotary motor according to claim 1, wherein
the second main pole magnet has a surface fixed to the rotor frame.

3. The rotary motor according to claim 1, wherein
the sub-pole magnet has a surface fixed to the rotor frame.

4. The rotary motor according to claim 1, wherein
ends of the adjacent first main pole magnets contact at the negative side in the first direction.

5. The rotary motor according to claim 1, wherein
the rotor frame has a plurality of projections and the sub-pole magnets are fixed between the projections.

6. The rotary motor according to claim 1, wherein
the first direction and an axial direction of the rotation shaft are the same direction.

7. The rotary motor according to claim 1, wherein
the first direction and an axial direction of the rotation shaft are orthogonal.

8. A robot arm comprising the rotary motor according to claim 1.

9. The robot arm according to claim 8, wherein
the rotary motor is the rotary motor according to claim 6, and
the rotation shaft has a through hole extending in the axial direction and an electric wire is inserted through the through hole.
